(19) United States
(12) Patent Application Publication
(10) Pub. No.: US 2026/0192267 A1
(43) Pub. Date: Jul. 9, 2026

(54) TUBE SHAKING WITH CIRCULAR MOTION AND UNIFORM ORIENTATION

(71) Applicant: OMNI INTERNATIONAL, INC., Kennesaw, GA (US)

(72) Inventors: William Z. TODD, Kennesaw, GA (US); Miles PRESTWOOD, Kennesaw, GA (US); Jason PAULSEL, Peachtree City, GA (US); John D. BUNTING, Roswell, GA (US); Paul H. ROBERTS, Kennesaw, GA (US)

(21) Appl. No.: 19/013,324

(22) Filed: Jan. 8, 2025

(51) Int. Cl. B01F 31/23; B01F 31/20; B01F 35/33

(52) U.S. Cl. CPC B01F 31/23; B01F 31/201; B01F 35/33

(57) ABSTRACT

An input shaft, a connector extending from the input shaft, and an output shaft rotationally connected to the connector and fixedly connected to a tube holder. Rotating the input shaft causes the tube holder to revolve about the input shaft, to shake the samples in tubes in the tube holder, but not to rotate about the output shaft. An orientation-maintaining device is operationally engaged between the input and output shafts so that rotation of the input shaft causes rotation of the output shaft in an opposite angular direction and in a same angular degree to maintain the tube holder in a uniform orientation during shaking so that uniform forces are applied to each of the tubes. In example embodiments, the orientation-maintaining device includes a fixed gear or other hub member, a rotary gear or other hub member, and an idler gear or other interfacing element engaged between them.

### TECHNICAL FIELD

The present disclosure relates generally to laboratory devices and methods for processing sample materials, and particularly to shaking devices used in homogenizing and other such devices and methods.

### BACKGROUND

Homogenization involves disaggregating, mixing, resuspension, or emulsifying the components of a sample using a high-shear process with significant micron-level particle-size reduction of the sample components. Homogenization is commonly used for a number of laboratory applications such as creating emulsions, reducing agglomerate particles to increase reaction area, cell destruction for capture of DNA material (proteins, nucleic acids, and related small molecules), DNA and RNA amplification, and similar activities in which the sample is bodily tissue and/or fluid, other organic material, or another substance.

Conventional high-powered mechanical-shear homogenization devices for such applications are commercially available in various designs to generate vigorous linear, circular, or “swashing” (modified sinusoidal) oscillating (reciprocating) motions and resulting forces. The samples are held in sample tubes, with a plurality of the sample-holding tubes mounted to a tube holder that is mounted to the homogenization device such that the vigorous oscillating forces are transmitted through the tube holders and the tubes to the contained samples.

These homogenization devices have proven generally beneficial in accomplishing the desired homogenization of the sample materials. But in use they have their disadvantages. For example, linear reciprocating motions tend to produce less of a grinding shear action on the samples and instead merely cause the samples to linearly traverse the lengths of the tubes (with little disaggregation) and smash/impact against the ends of the tubes (causing some disaggregation). In addition, the lesser grinding action means that longer run times are needed to produce the desired homogenization, which tends to create a lot of heat in the tubes, which can degrade the samples being processed.

Circular and other non-linear reciprocating motions tend to produce more of a grinding shear action on the samples to better disaggregate the samples. But they also produce oscillatory motion profiles in which the tubes, and the samples in them, are not all subjected to the same oscillating forces. Current homogenizing methods to achieve uniform processing (all of the sample-holding tubes are subjected to the same oscillatory forces), include removing and reorienting/repositioning the tubes mid-process. This takes additional time/effort and the result is not precise, with the resulting processing being closer to but still not uniform. As a result, current homogenization does not produce equivalent forces across all of the samples, and this known error/deficiency invalidates any comparison of downstream results from two or more of the tubes.

As such, current sample homogenizing devices and methods tend to produce results that are slow/time-consuming, inconsistent, or both.

### SUMMARY

Generally described, the present disclosure relates to shaking devices of processing devices for vigorously shaking samples contained in tubes held by tube holders. In example embodiments, the shaking device includes a rotary input shaft, a rotary output shaft, a connector, and an orientation-maintaining device.

The rotary input shaft defines an input axis and is driven through a rotating input motion about the input axis. The rotary output shaft defines an output axis, is driven through a rotating output motion about the output axis, is offset from and parallel to the input shaft, and is fixedly connected to the tube holder. And the connector extends between the output shaft and the input shaft, is fixedly connected to the input shaft so that the connector rotates with the input shaft, and is rotationally connected to the output shaft. In this way, the rotating input motion of the input shaft drives the output shaft, and the fixedly connected tube holder, through a revolving motion about the input axis, but not through the rotating output motion, to shake the tubes through an orbital (e.g., circular) motion profile.

The orientation-maintaining device is operationally engaged between the input shaft and the output shaft. The orientation-maintaining device is adapted to rotationally drive the output shaft, in response to the rotating input motion of the input shaft, through the rotating output motion in an opposite angular direction and in a same angular degree relative to the rotating input motion. As such, during shaking use the rotating output shaft maintains the tube holder and the tubes in a uniform orientation as the output shaft, and the fixedly connected tube holder, are driven through the revolving motion about the input axis. The result is that uniform forces are applied to each of the tubes and the samples contained therein to process the samples. For example, throughout the circular motion profile during shaking use, the tube holder can be level and the tubes can be upright in the uniform orientation while the tube holder revolves about the input axis.

In typical embodiments, the orientation-maintaining device includes a fixed hub member and a rotary hub member. The fixed hub member is typically fixedly connected in place and not rotationally driven by the input shaft. The rotary hub member is typically rotational with and fixedly connected to the output shaft. The rotary hub member is driven through the rotating output motion by indirect engagement with the fixed hub member when the output shaft is driven through the revolving motion about the input axis.

In some embodiments, the fixed hub member and the input shaft are coaxially arranged about the input axis. For example, the fixed hub member can be annular and concentrically arranged around the input shaft, and a rotational bearing can be mounted between the fixed hub member and the input shaft so that the connector rotates with the input shaft but the fixed hub member does not.

Typically, the rotary hub member is rotational relative to the connector but not relative to the output shaft. Also typically, the input shaft and the connector are rotational relative to the fixed hub member. Further, the fixed hub member and the rotary hub member have the same operating diameter.

In some embodiments, the fixed and rotary hub members are fixed and rotary gears in an epicyclic gearset arrangement. For example, the fixed hub member can be a fixed sun gear, the rotary hub member can be a rotary planet gear, and at least one idler gear can be engaged between the sun gear and the planet gear in the epicyclic gearset arrangement.

In other embodiments, the fixed and rotary hub members are fixed and rotary pulleys in a pulley-set arrangement. For example, the fixed hub member can be a fixed pulley, the rotary hub member can be a rotary pulley, and a belt can be routed around the fixed pulley and the rotary pulley.

In typical embodiments, the shaking device also includes a counterweight connected to the input shaft and positioned opposite from the output shaft to counterbalance the tube holder during shaking use. Further, the connector can include a housing that houses the orientation-maintaining device and the counterweight.

Another example embodiment includes a processing device that shakes a tube holder and tubes to process samples. The processing device includes a shaking device of a type described herein, a rotary drive system that engages and drives the rotary input shaft, a control system that controls operation of the drive system, and a frame that supports the shaking device, the drive system, and the control system.

In other example embodiments, the shaking device includes a rotary input, a rotary output shaft, a connector, a counterweight, and an orientation-maintaining device. The rotary input shaft defines an input axis and driven through a rotating input motion about the input axis. The rotary output shaft defines an output axis, is driven through a rotating output motion about the output axis, is offset from and parallel to the input shaft, and is fixedly connected to the tube holder. The connector extends between the output shaft and the input shaft, is fixedly connected to the input shaft so that the connector rotates with the input shaft, and is rotationally connected to the output shaft. In this way, the rotating input motion of the input shaft drives the output shaft, and the fixedly connected tube holder, through a revolving motion about the input axis, but not through the rotating output motion, to shake the tubes through a circular motion profile. And the counterweight is connected to the input shaft and positioned opposite from the output shaft to counterbalance the tube holder during shaking use.

The orientation-maintaining device includes a fixed gear and a rotary gear. The fixed gear is fixedly connected in place and not rotationally driven by the input shaft. The rotary gear is rotational with and fixedly connected to the output shaft. The rotary gear, and the fixedly connected output shaft, is driven through the rotating output motion, in an opposite angular direction and in a same angular degree relative to the rotating input motion, by indirect engagement with the fixed gear when the output shaft is driven through the revolving motion about the input axis. The rotating output motion of the output shaft maintains the tube holder and the tubes in a uniform orientation during shaking use as the output shaft, and the fixedly connected tube holder, are driven through the revolving motion about the input axis. In this way, uniform forces are applied to each of the tubes and the samples contained therein to homogenize the samples.

In some embodiments, the fixed and rotary gears form an epicyclic gearset arrangement. For example, the fixed gear can be a fixed sun gear, the rotary gear can be a rotary planet gear, and at least one idler gear can be engaged between the sun gear and the planet gear in the epicyclic gearset arrangement.

In some embodiments, the fixed gear and the input shaft are coaxially arranged about the input axis. For example, the fixed gear can be annular and concentrically arranged around the input shaft, and a rotational bearing can be mounted between the fixed gear and the input shaft so that the connector rotates with the input shaft but the fixed hub member does not.

Typically, the rotary gear is rotational relative to the connector but not relative to the output shaft. Also typically, the input shaft and the connector are rotational relative to the fixed gear. Further, the fixed gear and the rotary gear have the same operating diameter, that is, they have a 1:1 gear ratio.

Another example embodiment includes a homogenizer that shakes a tube holder and tubes to process samples by homogenization. The homogenizer includes a shaking device of a type described herein, a rotary drive system that engages and drives the rotary input shaft, a control system that controls operation of the drive system, and a frame that supports the shaking device, the drive system, and the control system.

The specific techniques and structures employed to improve over the drawbacks of the prior devices and accomplish the advantages described herein will become apparent from the following detailed description of example embodiments and the appended drawings and claims.

### BRIEF DESCRIPTION OF THE DRAWINGS

FIG. 1 is a perspective view of a portion of a processing device including a shaking device according to a first example embodiment, with a housing of the processing device removed to reveal the internal components shown, and with the shaking device driving a tube holder carrying tubes.

FIG. 2 is a perspective view of the shaking device of FIG. 1, shown with an alternative tube holder and tubes.

FIG. 3 is a side view of the shaking device of FIG. 2.

FIG. 4 shows a portion of the shaking device of FIG. 3 in a first position.

FIG. 5 is a perspective view of the shaking device, tube holder, and tubes of FIG. 2, shown in the first position of FIG. 5 with the tubes in an upright orientation.

FIG. 6 shows the shaking device portion of FIG. 5 rotated to a second position.

FIG. 7 shows the shaking device, tube holder, and tubes of FIG. 6 in the second position of FIG. 6 with the tubes maintained in the upright orientation.

FIG. 8 shows the shaking device portion of FIG. 6 rotated to a third position.

FIG. 9 shows the shaking device, tube holder, and tubes of FIG. 7 in the third position of FIG. 8 with the tubes maintained in the upright orientation.

FIG. 10 shows the shaking device portion of FIG. 8 rotated to a fourth position.

FIG. 11 shows the shaking device, tube holder, and tubes of FIG. 9 in the fourth position of FIG. 10 with the tubes maintained in the upright orientation.

FIG. 12 is a schematic view of the shaking device and tube holder of FIGS. 4-5 in the first position.

FIG. 13 shows the schematic view of FIG. 12, with the shaking device and the tube holder in the second position of FIGS. 6-7, with the output shaft and tube holder rotated in an opposite angular direction from the input shaft.

FIG. 14 is a side view of a shaking device according to a second example embodiment, for use in a processing device, with the shaking device driving a tube holder carrying tubes.

FIG. 15 shows a portion of the shaking device of FIG. 14 without the tube holder and tubes.

### DETAILED DESCRIPTION OF EXAMPLE EMBODIMENTS

Generally described, the present disclosure relates to shaking (i.e., agitation) devices of homogenization devices for generating orbital (e.g., circular) oscillating (cyclical) motions and resulting forces on a plurality of tubes mounted to the device and thus to samples contained in the tubes. By the use of the shaking devices, the oscillating forces on the samples in the tubes tend to cause the samples to move not just back and forth between the ends of the tubes (i.e., along the axial lengths of the tubes) but also somewhat transversely (i.e., laterally) back and forth between the sides of the tubes (i.e., across the widths of the tubes) to produce a grinding shear action to better homogenize the samples and to avoid excess heat generation. Furthermore, the tubes and samples are all moved through the same orbital motion profile while being maintained in a uniform orientation throughout the entire motion profile so that they all experience uniform oscillatory forces to provide uniform and consistent processing results.

It should be noted that the shaking devices can be used with different types of homogenization devices, tube holders, tubes, and sample materials, and as such these terms as used herein are intended to be broadly construed. A few preliminary definitions are as follows. These definitions are all in the context of laboratory processing equipment and methods, with the term “laboratory” intended to be broadly construed to mean any type of controlled sterile environment used for processing samples, including clinical diagnostic and pathology laboratories, academic and industry research laboratories, and teaching laboratories.

“Processing” as used herein is intended to be broadly construed to mean high-shear disaggregating, with significant micron-level particle-size reduction (and optionally mixing and/or resuspending) of the components of a sample, by using a processing device to generate an oscillating motion of a tube containing the sample. Example types of processing include homogenizing, emulsifying, lysing, grinding, pulverizing, blending, mixing, resuspending, and other uses/applications of laboratory processing devices (e.g., dissociating, separating, rupturing, combining, cutting, crushing, and breaking apart).

“Processing device” as used herein is intended to be broadly construed to mean a laboratory device that is operable to drive tubes holding samples through an oscillatory motion to process the samples. A common but non-exclusive example processing device is a bead mill homogenizer, for example BEADRUPTER bead mill homogenizers (Omni International, Inc., Kennesaw, GA), that operates to homogenize the samples.

“Sample” as used herein is intended to be broadly construed to include any type of material that can be processed and for which processing could be useful, such as but not limited to human and/or non-human bodily fluid and/or tissue (e.g., blood, bone-marrow cells, a coronary artery segment, a piece of an organ, or whole or parts of insects or other animals), other organic matter (e.g., plants or food), and/or other substances (e.g., soil), chemicals, or biological materials.

“Tube” is intended to be broadly construed to include any closable/sealable vessel or container that can hold a sample (sometimes also holding a grinding media such as beads) during processing, and is not limited to conventional cylindrical hard-plastic vials with screw-on caps and thus also includes wells (e.g., of well plates), conical, polygonal, or other-shaped vials, and other types of elongated, spherical, or other-shaped vessels and containers.

“Tube holder” is intended to be broadly construed to include any retaining structure that can hold a plurality of sample tubes during processing and that can be operably driven by a shaking device, and is not limited to conventional racks (e.g., SBS racks), carriages (e.g., directly holding tubes, or indirectly holding tubes (e.g., holding a rack or other tuber-holding structure that in turn directly holds tubes), plates (e.g., of well plates), trays, cassettes, clamps, or other types of tube-holding structures, with typical tube holders having a rectangular footprint and holding an array (e.g., 3×6) of tubes.

“Circular” and “orbital” when describing the motion profile of the tubes/samples means rotating about an axis that is typically not vertical (as in conventional centrifuges) and that is not parallel with the longitudinal/shaking axes of the tubes (for tubes that are elongated)(as in conventional centrifuges), instead the tubes/samples are rotating about an axis that is typically horizontal (or otherwise non-vertical) and that is transverse to the longitudinal/shaking axes of the tubes (for tubes that are elongated). Also, the tubes/samples are rotating about an axis that is not in a fixed relationship to the longitudinal axes of the tubes.

And “uniform orientation” and “uniform forces” when describing the tube holder and the tubes (including the samples contained in them) means that all of the tubes/samples held by the tube holder and being processed together are moved through the same orbital (e.g., circular) motion profile, revolving about an input axis that is transverse to the longitudinal axes of the tubes (for tubes that are elongated), while being maintained in the same orientation throughout the entire orbital motion profile, so that the tubes/samples all experience the same oscillatory inertial forces (for the same duration and frequency) to provide uniform and consistent processing results. For example, during each circular oscillation (cycle) of a horizontally oriented (substantially level) tube holder holding an array of conventional vial-type tubes each in an upright (substantially vertical) orientation, the tube holder remains in the same horizontal orientation at all times, and thus the tubes remain in the same upright orientation at all times, so the tubes/samples all experience the same oscillatory forces, without regard to how far away they are from the rotational output axis (or the rotational input axis). Thus, the sample-laden tubes each experience vertical motion and forces (up and down) and horizontal-depth motion and forces (front and back sideways), but not horizontal-width motion and forces (left and right sideways).

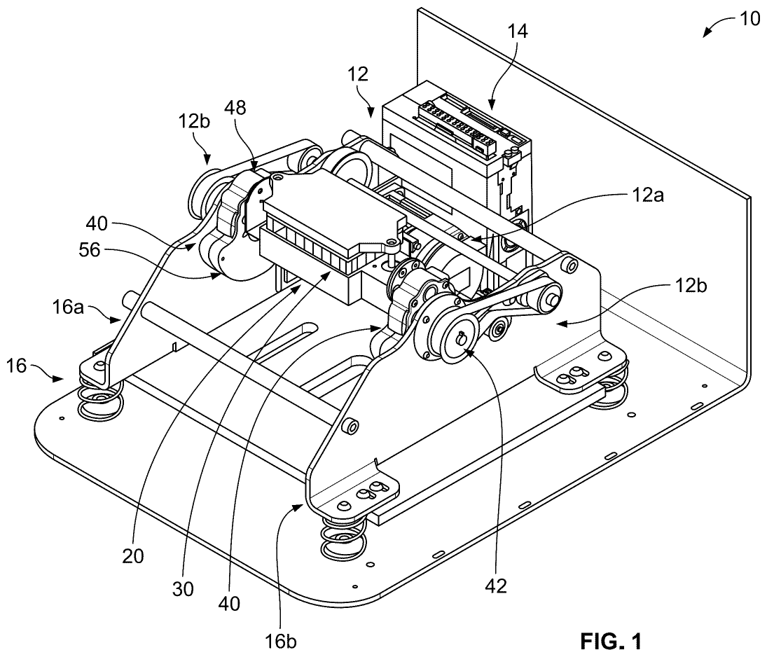

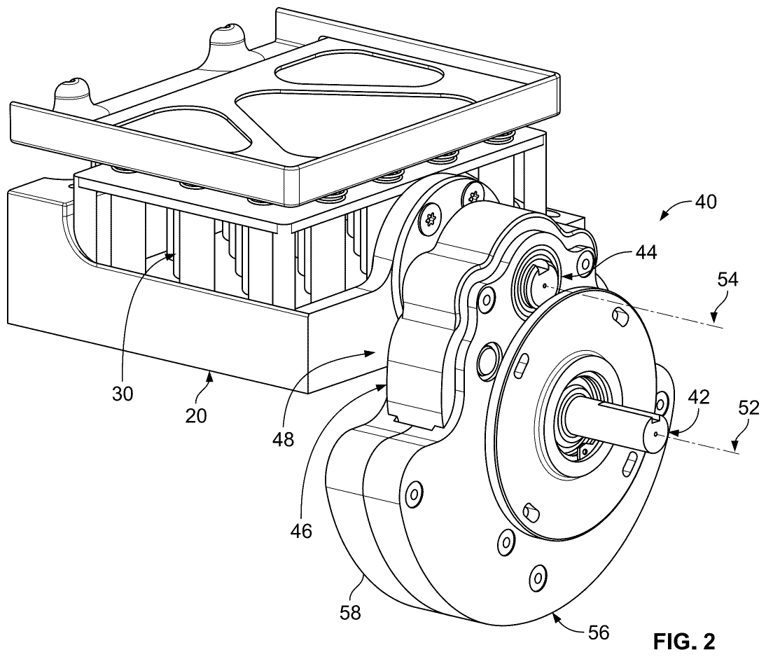

Turning now to the drawings, FIGS. 1-11 show a portion of processing device 10 including a shaking device 40 according to a first example embodiment. Referring particularly to FIGS. 1-2, the processing device 10 that the shaking device 40 is incorporated into can be a laboratory homogenizer (e.g., as depicted), or another conventional or future-designed processing device. For example, the processing device 10 can be a modified bead mill homogenizer, for example a BEADRUPTER bead mill homogenizer (Omni International, Inc., Kennesaw, GA).

The shaking device 40 operates to generate and transmit circular oscillating motions and resulting forces through a tube holder 20 holding a plurality of tubes 30 each containing a sample material to process the sample. Thus, the oscillating forces are transferred to and through the tube holder 20, then to and through the tubes 30, and then to the samples to process them. The tube holder 20 can include a carriage that directly connects to the shaking device 40 and that removably holds one or more racks, plates, trays, or the like that each hold (or include) a plurality (e.g., an array) of the tubes 30 (as depicted), for example as disclosed by U.S. Provisional Patent Application Ser. No. ______, filed Jan. 8, 2025, and titled CARRIAGE WITH CLAMP PLATE FOR SECURING SAMPLE-PROCESSING TUBES, which is hereby incorporated by reference herein. Alternatively, the tube holder can include a rack, plate, tray, or the like that connects directly to the shaking device 40 and that holds a plurality of the tubes 30, or it can be provided in another conventional or future design. Also, the tubes 30 can be of a conventional type, for example, elongated vials (as depicted), wells (e.g., of well plates), or other conventional or future-designed elongated tubes. If desired, the shaking device 40 can be used with only one tube 30 in the tube holder 20. And in some embodiments, the tube holder holds only one tube.

The processing device 10 typically includes a drive system 12 for driving the shaking device 40, a control system 14 for operating the drive system 12, a frame 16 that supports the shaking device 40, the drive system 12, and the control system 14, and a housing (not depicted) for at least partially enclosing these components. The drive system 12 typically includes an electric rotary motor 12a operably linked to and driving the shaking device 40, for example by a roller-and-belt linkage 12b (such as a first roller driven by the motor, a second roller driving the shaking device 40, and a belt routed around the rollers to transfer rotational motion from the motor to the shaking device 40, as depicted), or by a chain, hydraulics, or another system that translates rotary energy .. The control system 14 typically includes a programmed controller, input devices (e.g., buttons and a keypad), and output devices (e.g., a display screen), for providing functions such as on/off, start/stop, speed, and time. An electric power connection (e.g., a power cord) or source (e.g., battery) is typically included for powering the drive system 12 and the control system 14. The frame 16 typically includes two opposing side frame members with the shaking device 40 extending and mounted between them. These major components of the processing device 10 can be of a conventional type well known in the art, so exacting details are not included herein.

Referring particularly to FIGS. 2-4, the shaking device 40 includes a rotary input shaft 42, a rotary output shaft 44, a connector46 extending between the input shaft 42 and the output shaft 44, and an orientation-maintaining device 48. These components can be made of conventional materials (e.g., metal) using conventional fabrication techniques and equipment.

Typically, multiple of the shaking devices 40 are included in each of the processing devices 10. For example, two shaking devices 40 can be provided, with each connected at a respective end/side of the tube holder 20 and supported by a respective one of the side frame members 16a-b, as depicted. In other embodiments, one shaking device can be provided connected at one end of the tube holder, four shaking devices can be provided with each connected at a respective corner of a carrier frame supportingly mounted to the tube holder, or these or other numbers of the shaking devices can be provided in other arrangements.

The rotary input shaft 42 defines an input axis 52 and is driven through a rotating input motion about the input axis 52. The input shaft 42 is driven through its rotating input motion by the drive system 12 (e.g., by the depicted roller-and-belt linkage 12b). The rotary input shaft 42 is typically supported by, and rotationally mounted to, the frame member 16 of the processing device 10, for example by a conventional rotational bearing.

The rotary output shaft 44 defines an output axis 54 and is driven through a rotating output motion about the output axis 54. The output shaft 44 is fixedly connected to the tube holder 20, for example by conventional mounting elements such as a flange and bolts, as depicted, or by other conventional fasteners (e.g., bolts or screws), clamps, brackets, and/or the like. In some embodiments, the fixed connection of the output shaft 44 to the tube holder 20 includes a conventional detachment or release feature that enables the tube holder 20 to be removed from and replaced onto the output shaft 44 for each use, with the tube holder 20 still moving with the output shaft 44 when mounted in place during use. In this way, rotation of the output shaft 44 through its rotating output motion about the output axis 54 also rotates the tube holder 20 correspondingly about the output axis 54. The output shaft 44 is driven through its rotating output motion by the orientation-maintaining device 48, as detailed below.

The output shaft 44 is offset from and parallel to the input shaft 42, with the connector46 extending between them. The connector46 is fixedly connected to the input shaft 42, for example including conventional shaft key features (e.g., tabs and slots), fasteners (e.g. bolts or screws), clamps, and/or the like, so that the connector46 rotates with the input shaft 42 about the input axis 52. The connector46 is rotationally connected to the output shaft 44, for example by a conventional rotational bearing, so that the output shaft 44 is radially retained by the connector46 but free to rotate relative to the connector46. As such, the rotating input motion of the input shaft 42 drives the output shaft 44, and the fixedly connected tube holder 20, through a revolving motion about the input axis 52, but not through the rotating output motion about the output axis 54.

In this way, the connector46 is a crank arm that transfers the rotating input motion of the input shaft 42 to the revolving motion of the output shaft 44, without affecting rotation of the output shaft 44 about the output axis 54 (which is controlled by the orientation-maintaining device 48, as detailed below). Thus, the output shaft 44 revolves about the input axis 52 but does not rotate about the output axis 54. The revolving motion of the tube holder 20 about the input axis 52 shakes the tubes 30 (and the samples in them) through a circular motion profile to vigorously process the samples.

To provide counterbalance to minimize vibrations during vigorous shaking, the shaking device 40 typically includes a counterweight 56. In example embodiments, the counterweight 56 is fixedly connected to the input shaft 42 (e.g., by conventional shaft key features, fasteners, clamps, and/or the like) and extends from the input shaft 42 oppositely away from the output shaft 44 (and thus the tube holder 20) to counterbalance the tube holder 20 during shaking use. The counterweight 56 can be of a conventional type, having a conventional shape (e.g., semi-circular wedged-shaped, as depicted) and made of a conventional material (e.g., metal). The counterweight 56 balances the mass of the tube holder 20, tubes 30, and samples, during the high-speed oscillations, and in some embodiments the counterweight can be adjustable for different speeds of oscillation, masses to be balanced, etc. In example embodiments, the tube holder 20 and the sample-laden tubes 30 are balanced with their combined center of mass as close as reasonably possible to the output axis 54, and then the counterweight 56 is selected to counter-balance (as best as reasonably possible) the combined weight of the tube holder 20 and the sample-laden tubes 30 so that the center of mass of the entire assembly is as close as reasonably possible to the input axis 52. Also, in some embodiments the counterweight may not be needed, for example if there are opposing/counter-balancing tube holders on the processing device, if the shaking device is strong enough to handle the offset/imbalance and resulting forces, etc.

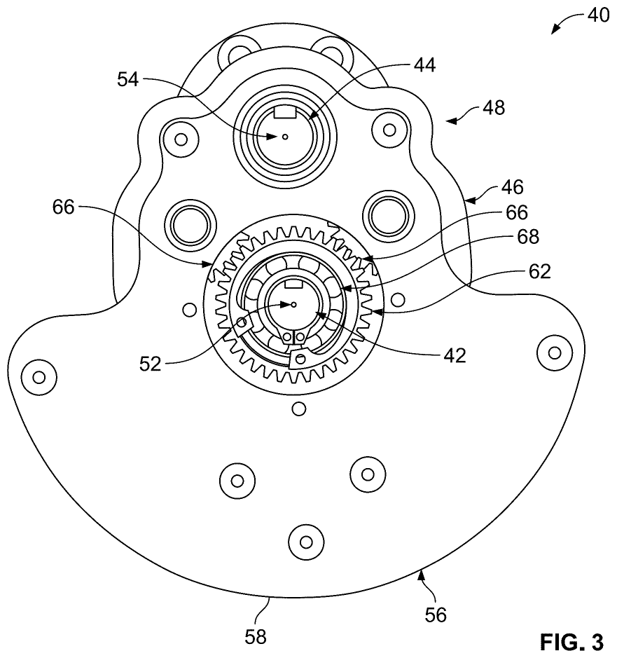

In example embodiments, the connector 46 includes a housing 58 that houses the orientation-maintaining device 48 and the counterweight 58. The housing 56 can enclose substantially all of the orientation-maintaining device 48 and the counterweight 56, as depicted in FIG. 3. In other embodiments, the housing encloses only a portion of the orientation-maintaining device 48 and the counterweight 56, or it supports but does not enclose them. In the depicted embodiment, the housing is shaped to generally conform to the housed components, though in other embodiments the housing can be circular (disk-shaped) or have another symmetrical or other shape.

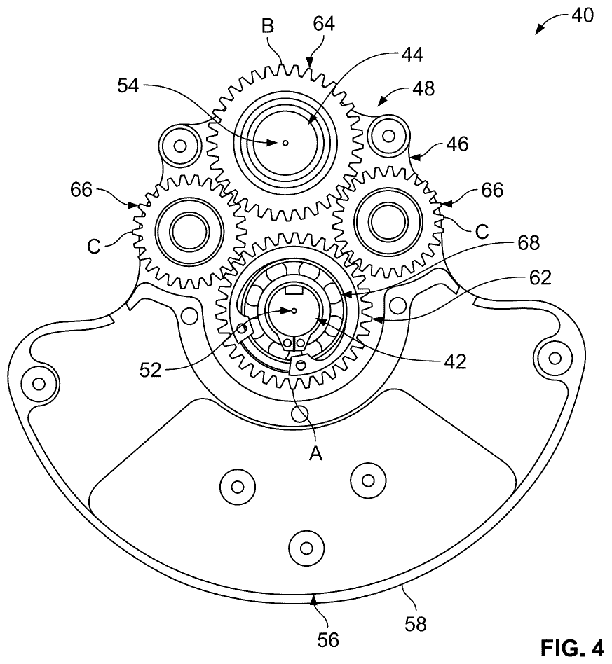

Referring particularly to FIGS. 4-13, details of the construction and operation of the orientation-maintaining device 48 will now be described. The orientation-maintaining device 48 is operationally engaged between the input shaft 42 and the output shaft 44. The orientation-maintaining device 48 uses the revolving motion of the output shaft 44 about the input axis 52 to drive rotation of the output shaft 44 about the output axis in an opposite angular direction and in a same angular degree relative to the input shaft 42. Thus, the orientation-maintaining device 48 rotationally drives the output shaft 44, in response to the rotating input motion of the input shaft 42, through the rotating output motion in the opposite angular direction from the rotating input motion and in the same angular degree as the rotating input motion. The result of this use of the orientation-maintaining device 48 is that the shaking device 40 changes circular motion (which would otherwise produce centrifugal forces that exceed gravity and “pin” the sample to the bottom of the tube) into alternating forces moving the sample from one end of the tube to the other.

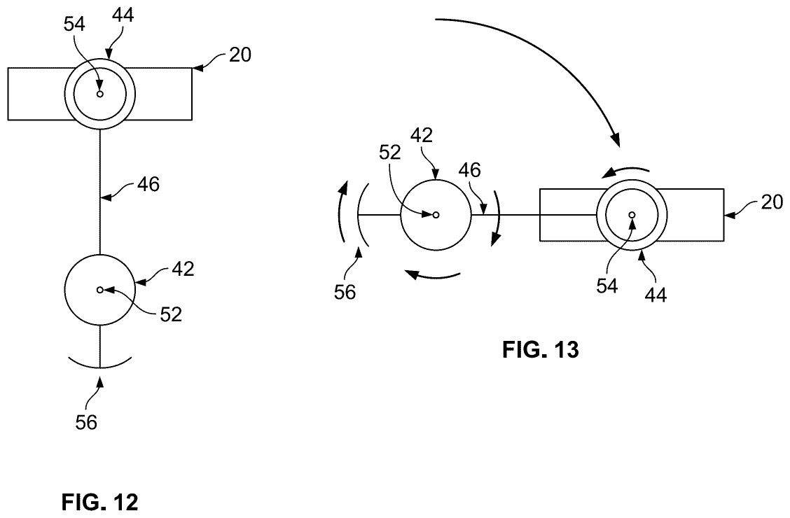

In this way, during shaking use, the rotating output shaft 44 maintains the tube holder 20 and the tubes 30 in a uniform orientation as the output shaft 44, and the fixedly connected tube holder 20, are driven through the revolving motion about the input axis 52, as schematically depicted in FIGS. 12-13. This uniform orientation of the tubes 30, including the samples held within them, results in uniform forces being applied to each of the tubes 30 and samples, to uniformly process all of the samples. This is the result regardless of how far away the tubes are from the rotational output axis (or the rotational input axis).

For example, for a level (substantially horizontally oriented) tube holder 20 holding a plurality of upright (substantially vertically oriented) tubes 30, during each 360-degree oscillatory revolution/cycle (about the input axis 52), the tube holder 20 remains level at all times throughout the circular motion profile, and thus the tubes 30 remain upright at all times throughout the circular motion profile. The same applies to other orientations of the tube holder 20 and the tubes 30; the starting tube orientation is not critical, but maintaining the same tube orientation throughout the oscillatory circular motion is.

The depicted shaking device 40 drives the tube holder 20 and tubes 30 through a circular motion, but in other embodiments the shaking device is configured to drive the tube holder 20 and tubes 30 through an elliptical or other orbital motion about the input axis 52. In such embodiments, the orientation-maintaining device is adapted correspondingly as needed to maintain the tube holder 20 and the tubes 30 in a uniform orientation. As such, the motion need not be purely circular, and instead in some embodiments it can vary from purely circular by being for example elliptical..

In example embodiments, the orientation-maintaining device 48 includes a fixed hub member 62, a rotary hub member 64, and one or more inter-engaging elements 66 that are drivingly engaged between them. The fixed hub member 62 and the rotary hub member 64 can be provided by various different structures, including gears (e.g., as described below), pulleys (e.g., as described below), sprockets (e.g., chains), or other conventional hub elements (e.g., wheels, annular hoops, and the like). And the inter-engaging elements 66 can be provided by various different structures, including idler gears (e.g., as described below), pulley belts (e.g., as described below), or other conventional linkages (e.g., rods, bars, arms, plates, or the like).

The fixed hub member 62 is fixedly connected in place so that it does not rotate or otherwise move relative to the input shaft 42. In typical embodiments, the fixed hub member 62 is fixedly connected (e.g., by conventional mounting elements such as a flange and bolts, as depicted, or by other conventional fasteners (e.g., bolts or screws), clamps, brackets, and/or the like) to one of the frame members 16a-b or another fixed structure of the processing device 10.

In typical embodiments, the fixed hub member 62 and the rotary input shaft 42 are coaxially arranged about the input axis 52. The input shaft 42 rotates through the input motion about the input axis 52, as noted above, but the fixed hub member 62 is fixed in place so that it does not rotate about the input axis 52. To permit the rotary input shaft 42 to rotate, while the coaxial fixed hub member 62 does not, a rotational bearing 68 can be provided between these two components. For example, the fixed hub member 62 can be annular and concentrically arranged about the input shaft 42, and the rotational bearing 68 can be of a conventional journaled type and rotationally mount the fixed hub member 62 onto the input shaft 42. In this way, the connector 46 rotates with the input shaft 42 but the fixed hub member 62 does not. In other embodiments, the fixed hub member and the rotary input shaft are laterally offset from each other, whether coaxial or not, without need for the rotational bearing. In other embodiments, the fixed hub member and the rotary input shaft are not coaxial and/or they are separately mounted (e.g., to the frame member 16).

The rotary hub member 64 is fixedly connected to the output shaft 44 (e.g., by the depicted keyway and spline, or by other conventional fasteners, brackets, clamps, flanges, or the like, or by being integrally formed together) so that the rotary hub member 64 rotates with the output shaft 44 about the output axis 54. That is, rotation of the rotary hub member 64 about the output axis 54 also rotates the output shaft 44, and thus the tube holder 20, about the output axis 54. Accordingly, the rotary hub member 64 is rotational relative to the connector46 but not relative to the output shaft 44, and the input shaft 42 and the connector46 are together rotational relative to the fixed hub member 62.

The inter-engaging elements 66 are drivingly engaged between the fixed hub member 62 and the rotary hub member 64 so that revolution of the rotary hub member 64 about the input axis 52 in a first angular direction causes rotation of the rotary hub member 64 about the output axis 54 in a second angular direction that is opposite to the first angular direction. Also, the fixed hub member 62 and the rotary hub member 64 have a same/common operating diameter so that the rotary hub member 64 (and thus also the output shaft 44 and the tube holder 20) has angular motions (revolution about the input axis 52 in the first angular direction and rotation about the output axis 54 in the second opposite angular direction) that are in the same/common degree (amount). In this way, when the output shaft 44 is driven through the revolving motion about the input axis 52, the rotary hub member 64 is driven through the rotating output motion about the output axis 54, in the opposite angular direction and in the same angular degree, by indirect engagement with the fixed hub member 62. As a result of this, the angular orientation of the output shaft 44, and thus the attached tube holder 20, remains the same as the output shaft 44 and tube holder 20 revolve about the input axis 52.

In example embodiments, the orientation-maintaining device 48 includes a gearset arrangement, with the fixed hub member 62 being a fixed gear, the rotary hub 64 member being a rotary gear, and the inter-engaging elements 66 being idler gears that mesh and inter-engage with the fixed and rotary gears 62 and 64. The fixed, rotary, and idler gears 62, 64, and 66 can be pinion gears, as depicted, or other types of meshing gears. The idler gears 66 are rotationally mounted (e.g., by conventional rotational bearings) and positioned between the fixed and rotary gears 62 and 64 to cause the rotary gear 64 to rotate through the output motion in the second opposite direction in response to its revolution (with the output shaft 44 and the connector46) about the input axis 52 in the first angular direction. Also, the fixed and rotary gears 62 and 64 have the same operating diameter, that is, they have a 1:1 gear ratio. As such, the rotary gear 64 (and thus also the output shaft 44 and the tube holder 20) has angular motions (revolution about the input axis 42 in the first angular direction and rotation about the output axis 44 in the second opposite angular direction) that are in the same/common degree (amount).

Accordingly, the rotary gear 64, and the fixedly connected output shaft 44, are driven through the rotating output motion, in an opposite angular direction and in the same angular degree relative to the rotating input motion, by indirect engagement with the fixed gear 60 when the output shaft 44 is driven through the revolving motion about the input axis 52. The rotating output motion of the output shaft 44 maintains the tube holder 20 and the tubes 30 in a uniform orientation during shaking use as the output shaft 44, and the fixedly connected tube holder 20, are driven through the revolving motion about the input axis 52. In this way, uniform forces are applied to each of the tubes 30 and the samples contained therein to homogenize the samples.

This innovative arrangement synchronizes rotation of the output shaft 44 (and the tube holder 20) to revolution of the output shaft 44 (and the tube holder 20) to maintain a uniform orientation of the output shaft 44 (and the tube holder 20) at all times during 360-degree revolutionary cycles of oscillation to process all of the samples uniformly. In addition, this innovative arrangement provides this synchronization using only one rotationally driven axis (the input shaft 42), without a separate/second rotationally driven axis/shaft for the orientation-maintaining device 48 (the output axis 44 is not rotationally driven by the input axis 42 or any other drive component). Furthermore, there is only one axis of revolution (the input axis 52) for the tube holder 20 and tubes 30 as they travel through their circular oscillatory revolving motion in their uniform orientation. And the resulting uniform forces on the sample-laden tubes 30 includes the same inertial forces applied at the top and bottom of the tubes.

For example, the depicted orientation-maintaining device 48 includes an epicyclic (planetary) gearset arrangement, with the fixed hub member 62 being a fixed sun gear, the rotary hub member being a rotary planet gear 64, and the inter-engaging elements 66 being two idler gears that each mesh and inter-engage with both the fixed sun gear 62 and the rotary planet gear 64. The idler gears 66 are rotationally mounted to the connector46 so that they revolve (with the output shaft 44 and the connector46) about the input axis 52. When the idler gears 66 revolve (along with the output shaft 44 and the connector46) in the first angular direction about the input axis 52, their engagement with the fixed gear 62 drives them through rotation (about their axes) in the same first angular direction, and in turn their engagement with the rotary gear 64 drives it through the output rotating motion in the second opposite angular direction.

In other embodiments, other epicyclic gearset arrangements can be used, for example with the fixed or rotary gear being a ring gear. And in still other embodiments, other types and arrangements of gearsets can be incorporated into the orientation-maintaining device 48.

Having described details of the construction of the orientation-maintaining device 48, details of its operation will now be described. FIGS. 4-13 show use of the shaking device 40 of the processing device 10 through one complete 360-degree revolutionary cycle of oscillation (as indicated by the upper angular directional arrows) to process a sample material.

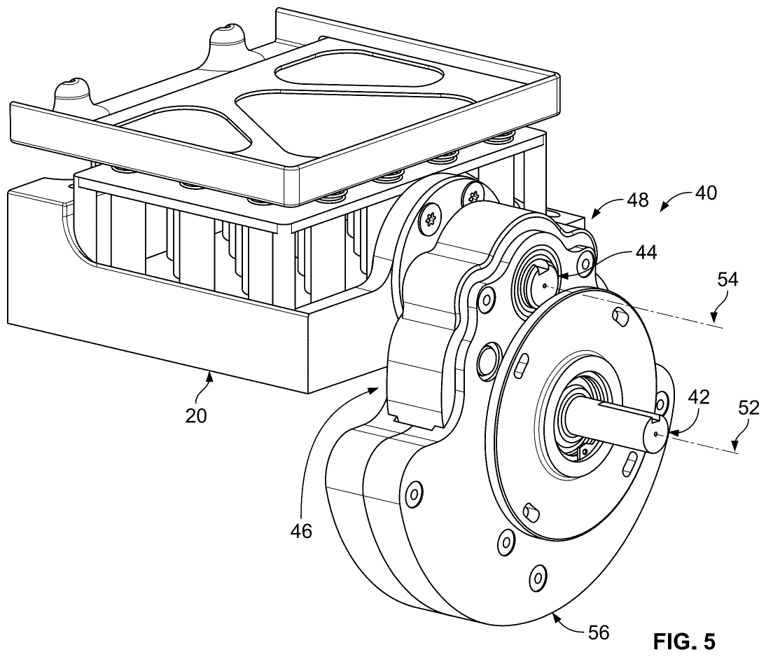

FIGS. 4-5 show the shaking device 40 with the tube holder 20 in a level orientation with the tubes 30 in an upright orientation. Location A of the fixed gear 62 is in the 6 o'clock position, location B of the rotary gear 64 is in the 12 o'clock position, and locations C of the idler gears 66 are in the 9 o'clock and 3 o'clock positions.

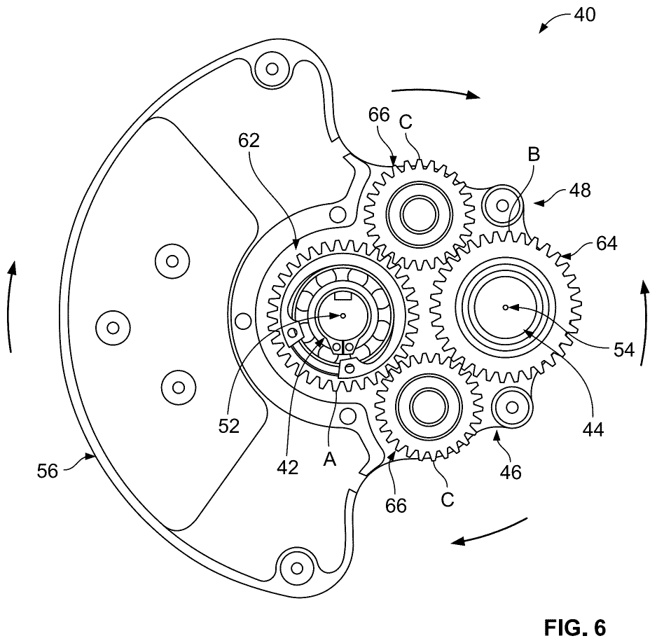

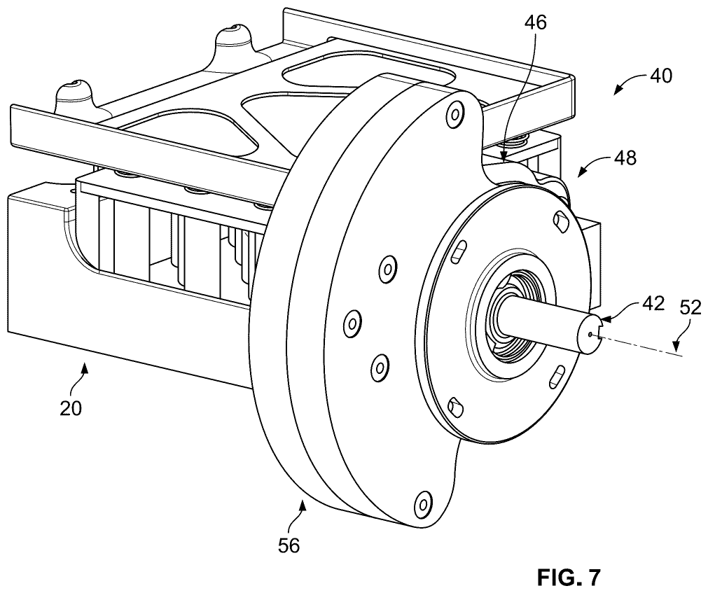

FIGS. 6-7 show the shaking device 40 operated by 90 degrees, with the input shaft 42 rotated about the input axis 52 by 90 degrees in the first angular direction, and thus with the connecting (crank arm) structure 46 and the output shaft 44 revolved about the input axis 52 by 90 degrees in the same/first angular direction. Location A of the fixed gear 62 remains in the 6 o'clock position, with locations C of the idler gears 66 rotated to the 12 o'clock and 6 o'clock positions, and with this resulting in location B of the rotary gear 64 rotated about the output axis 54 by 90 degrees in the second opposite angular direction. The output shaft 44 revolved about the input axis 52 by 90 degrees in the first angular direction, and rotated about the output axis 54 by 90 degrees in the second opposite angular direction, cancel each other out, so the output shaft 44 experiences no net angular motion (see also FIGS. 12-13 for a schematic representation of this). That is, instead of location B of the rotary gear 64 now being revolved by 90 degrees in the first angular direction to the 3 o'clock position, it remains in the 12 o'clock position. As such, the tube holder 20 is still in the same level orientation with the tubes 30 still in the same upright orientation.

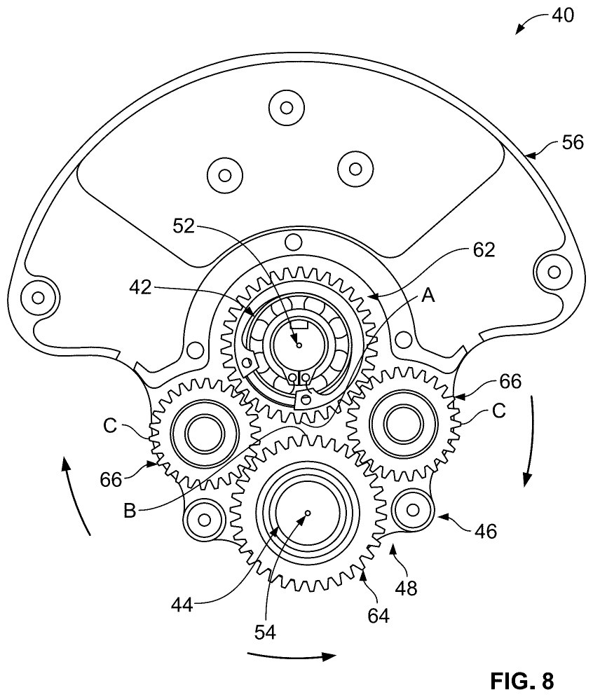

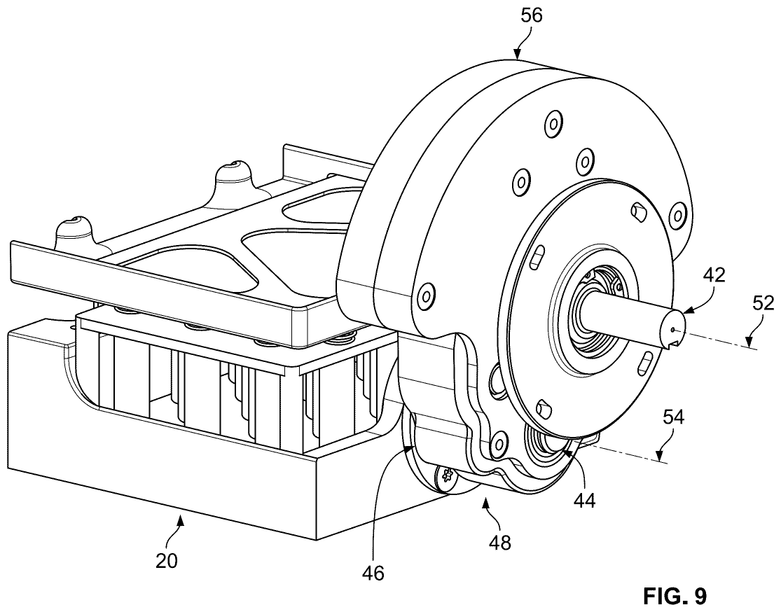

FIGS. 8-9 show the shaking device 40 operated further by an additional 90 degrees, with the input shaft 42 rotated further about the input axis 52 by an additional 90 degrees in the first angular direction, and thus with the connecting (crank arm) structure 46 and the output shaft 44 further revolved about the input axis 52 by an additional 90 degrees in the same/first angular direction. Location A of the fixed gear 62 remains in the 6 o'clock position, with locations C of the idler gears 66 rotated to the 3 o'clock and 9 o'clock positions, and with this resulting in location B of the rotary gear 64 rotated about the output axis 54 by an additional 90 degrees in the second opposite angular direction. Again, this additional rotation of the rotary gear 64 (and the fixedly connected output shaft 44) cancels out its additional revolution in the opposite direction, so the output shaft 44 experiences no net angular motion, and so location B of the rotary gear 64 remains in the 12 o'clock position, with the tube holder 20 still in the same level orientation and the tubes 30 still in the same upright orientation.

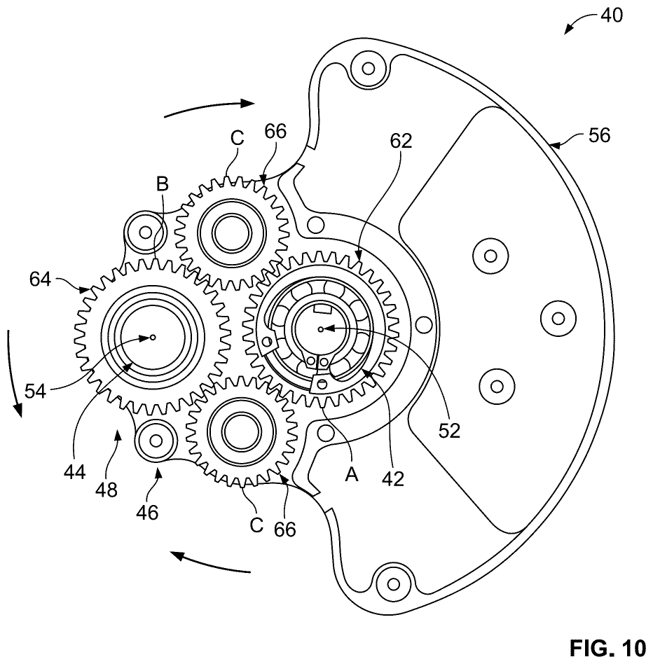

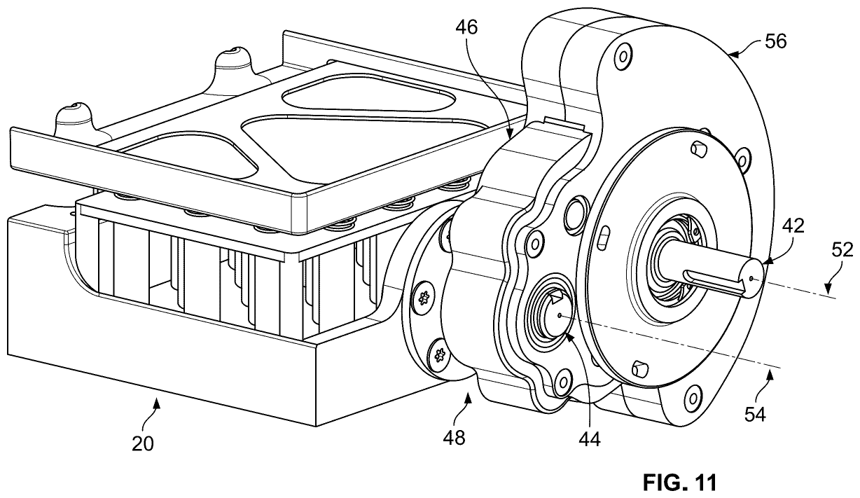

FIGS. 10-11 show the shaking device 40 operated further by an additional 90 degrees, with location A of the fixed gear 62 remaining in the 6 o'clock position, with locations C of the idler gears 66 rotated to the 6 o'clock and 12 o'clock positions, and with this resulting in location B of the rotary gear 64 rotated about the output axis 54 by an additional 90 degrees in the second opposite angular direction to cancel out its additional revolution so that it experiences no net angular motion. As such, location B of the rotary gear 64 remains in the 12 o'clock position, with the tube holder 20 still in the same level orientation the tubes 30 still in the same upright orientation. Further operation by an addition 90 degrees returns the shaking device 40 to the position of FIGS. 4-5.

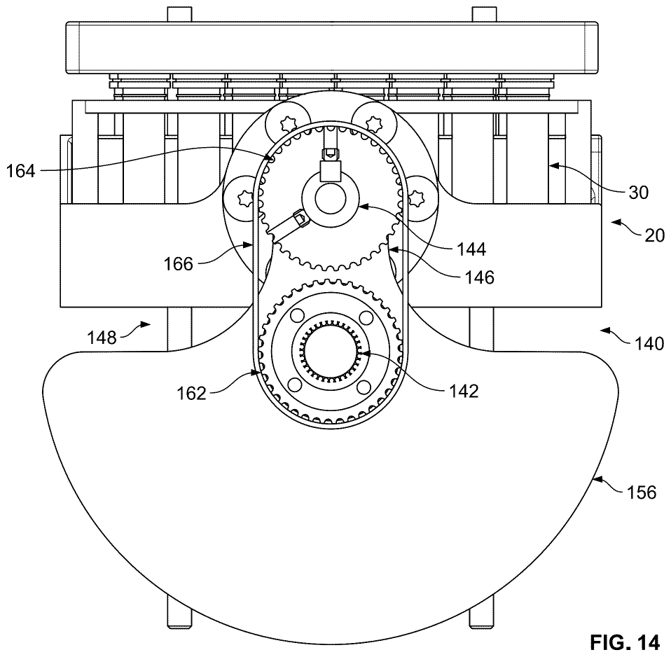

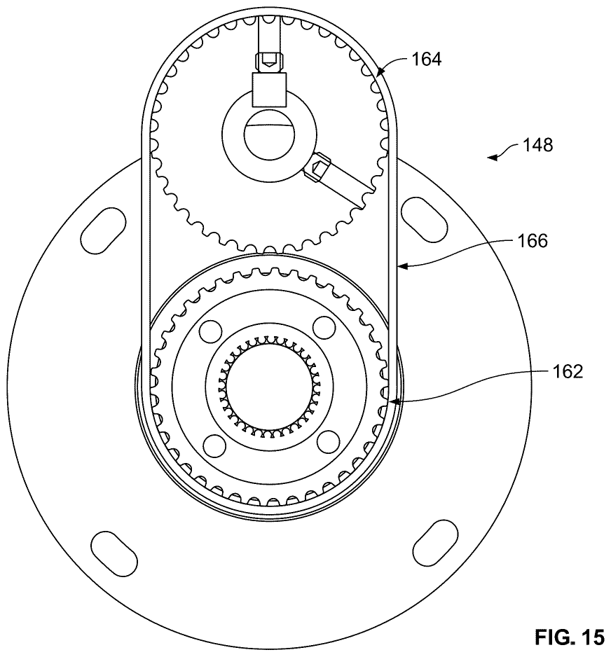

FIGS. 14-15 show a shaking device 140 according to a second example embodiment. The shaking device 140 can be incorporated into a homogenizer or other processing device of the type described herein, and it can be connected to a tube holder 20 (holding sample tubes 30) of the type described herein. As such, details of the processing device (not shown), tube holder 20, and tubes 30 are not repeated for brevity.

The shaking device 140 of the second embodiment is similar to that of the first embodiment described above, with exceptions as noted. Thus, the shaking device 140 includes a rotary input shaft 142, a rotary output shaft 144, a connector146 extending between the input shaft 142 and the output shaft 144, and an orientation-maintaining device 148. Also, a counterweight 156 is typically included for balancing the mass (of the tube holder 20, tubes 30, and samples) at oscillatory high speeds. These components can be made of conventional materials (e.g., metal) using conventional fabrication techniques and equipment.

The input shaft 142, the output shaft 144, the connector146, and the counterweight 156 are all typically of the same design as described above. While the orientation-maintaining device 148 includes the same innovation of counter-rotating the output shaft 144 and tube holder 20 to maintain their orientation during use, it implements this using a different structural design.

In particular, the orientation-maintaining device 148 includes a fixed hub member 162, a rotary hub member 164, and at least one inter-engaging element 166 operably engaged with the fixed and rotary hub members 162 and 164 to provide the functionality of counter-rotating the output shaft 144 and tube holder 20 to maintain their orientation during use. In this embodiment, however, instead of these components being provided by a gearset, they are provided by a pulley-set. That is, the fixed hub member is a fixed pulley 162, the rotary hub member is a rotary pulley 164, and the inter-engaging element is a belt 166 routed around the fixed and rotary pulleys 162 and 164. The fixed pulley 162 is fixed in place (e.g., mounted in a fixed position to the frame of the processing device) and does not rotate. The rotary pulley 164 is fixed to the tube holder 20 and radially retained by the connecting (crank arm) structure 146, which rotates about the input axis to revolve the output shaft 144 about the input axis. The belt 166 does not move relative to the fixed and rotary pulleys 162 and 164, and the pulleys 162 and 164 can include frictional belt-contacting surfaces (e.g., with treads, nubs, etc.) that prevent/minimize slippage between the belt and the pulleys 162 and 164.

The belt 166 connecting the fixed and rotary pulleys 162 and 164 maintains the parallelism of both the vertical and horizontal planes of the rotary pulley 164 relative to the corresponding vertical and horizontal planes of the fixed pulley 162 as the rotary pulley 164, tube holder 20, and connector146 revolve about the input axis defined by the input shaft 142. Neither of the pulleys 162 and 164 is driven through rotation, and so the belt 166 does not transmit rotary motion from a drive pulley to a driven pulley as in typical pulley-sets. Rather, the belt 166 is effectively a linkage extending from the fixed pulley 162 and engaging the rotary pulley 164 to rotate the connected output shaft 144 in the second angular direction opposite from its first angular direction of revolution as the rotary pulley 164, tube holder 20, and connector 146 revolve about the input axis defined by the input shaft 142.

In another embodiment, a laboratory homogenizer or other processing device is provided that integrally includes at least one shaking device that operates to homogenize or otherwise process the samples in the tubes in the tube holders. The processing device, and the tube holder and tubes, can be of types described herein or other conventional or future types.

It is to be understood that this disclosure is not limited to the specific devices, methods, conditions, or parameters of the example embodiments described and/or shown herein, and that the terminology used herein is for the purpose of describing particular embodiments by way of example only. Thus, the terminology is intended to be broadly construed and is not intended to be unnecessarily limiting of the claimed subject matter. For example, as used in the specification including the appended claims, the singular forms “a,” “an,” and “the” include the plural, the term “or” means “and/or,” and reference to a particular numerical value includes at least that particular value, unless the context clearly dictates otherwise. Also, any use of the terms “about,” “substantially,” and/or “generally” are intended to mean the exact value or characteristic indicated, as well as close approximations that are understood by persons of ordinary skill in the art to be sufficiently close to the exact value or characteristic based on the context of the intended use and application. In addition, any methods described herein are not intended to be limited to the sequence of steps described but can be carried out in other sequences, unless expressly stated otherwise herein.

While the claimed embodiments have been shown and described in example forms, it will be apparent to those skilled in the art that many modifications, additions, and deletions can be made therein without departing from the spirit and scope of the disclosure as defined by the following claims.

1. A shaking device, comprising:
a rotary input shaft defining an input axis and driven through a rotating input motion about the input axis;
a rotary output shaft defining an output axis, driven through a rotating output motion about the output axis, offset from and parallel to the input shaft, and fixedly connected to a tube holder, wherein the tube holder is configured to hold one or more tubes that contain one or more samples;
a connector extending between the output shaft and the input shaft, fixedly connected to the input shaft so that the connector rotates with the input shaft, and rotationally connected to the output shaft so that the rotating input motion of the input shaft drives the output shaft, and the fixedly connected tube holder, through a revolving motion about the input axis, but not through the rotating output motion, to shake the tubes through an orbital motion profile; and
an orientation-maintaining device operationally engaged between the input shaft and the output shaft and adapted to rotationally drive the output shaft, in response to the rotating input motion of the input shaft, through the rotating output motion in an opposite angular direction and in a same angular degree relative to the rotating input motion so that during shaking, the rotating output shaft maintains the tube holder and the tubes in a uniform orientation as the output shaft, and the fixedly connected tube holder, are driven through the revolving motion about the input axis such that uniform forces are applied to each of the sample tubes, thereby processing the one or more samples contained therein.

2. The shaking device of claim 1, wherein during shaking, throughout the orbital motion profile, the tube holder is level and the tubes are upright in the uniform orientation while the tube holder revolves about the input axis.

3. The shaking device of claim 1, wherein the orientation-maintaining device further includes a fixed hub member and a rotary hub member, wherein the fixed hub member is fixedly connected in place and not rotationally driven by the input shaft, wherein the rotary hub member is rotational with and fixedly connected to the output shaft, and wherein the rotary hub member is driven through the rotating output motion by indirect engagement with the fixed hub member when the output shaft is driven through the revolving motion about the input axis.

4. The shaking device of claim 3, wherein the fixed hub member and the input shaft are coaxially arranged about the input axis.

5. The shaking device of claim 4, wherein the fixed hub member is annular and concentrically arranged around the input shaft, further comprising a rotational bearing mounted between the fixed hub member and the input shaft so that the connector rotates with the input shaft but the fixed hub member does not.

6. The shaking device of claim 3, wherein the rotary hub member is rotational relative to the connector but not relative to the output shaft, and wherein the input shaft and the connector are rotational relative to the fixed hub member.

7. The shaking device of claim 3, wherein the fixed hub member and the rotary hub member have a same operating diameter.

8. The shaking device of claim 3, wherein the fixed and rotary hub members are fixed and rotary gears in an epicyclic gearset arrangement.

9. The shaking device of claim 3, wherein the fixed hub member is a fixed sun gear and the rotary hub member is a rotary planet gear, and further comprising at least one idler gear engaged between the sun gear and the planet gear in an epicyclic gearset arrangement.

10. The shaking device of claim 3, wherein the fixed hub member is a fixed pulley and the rotary hub member is a rotary pulley, and further comprising at least belt routed around the fixed pulley and the rotary pulley.

11. The shaking device of claim 1, further comprising a counterweight connected to the input shaft and positioned opposite from the output shaft to counterbalance the tube holder during shaking.

12. The shaking device of claim 11, wherein the connector houses the orientation-maintaining device and the counterweight.

13. The shaking device of claim 11, wherein the orbital motion profile is a circular motion profile.

14. A processing device comprising the shaking device of claim 1, a rotary drive system that engages and drives the rotary input shaft, a control system that controls operation of the drive system, and a frame that supports the shaking device, the drive system, and the control system.

15. A shaking device, comprising:
a rotary input shaft defining an input axis and driven through a rotating input motion about the input axis;
a rotary output shaft defining an output axis, driven through a rotating output motion about the output axis, offset from and parallel to the input shaft, and fixedly connected to a tube holder, wherein the tube holder is configured to hold one or more tubes that contain one or more samples;
a connector extending between the output shaft and the input shaft, fixedly connected to the input shaft so that the connector rotates with the input shaft, and rotationally connected to the output shaft so that the rotating input motion of the input shaft drives the output shaft, and the fixedly connected tube holder, through a revolving motion about the input axis, but not through the rotating output motion, to shake the tubes through a circular motion profile;
a counterweight connected to the input shaft and positioned opposite from the output shaft to counterbalance the tube holder during shaking; and
an orientation-maintaining device including a fixed gear and a rotary gear, wherein the fixed gear is fixedly connected in place and not rotationally driven by the input shaft, wherein the rotary gear is rotational with and fixedly connected to the output shaft, wherein the rotary gear, and the fixedly connected output shaft, is driven through the rotating output motion, in an opposite angular direction and in a same angular degree relative to the rotating input motion, by indirect engagement with the fixed gear when the output shaft is driven through the revolving motion about the input axis, and wherein the rotating output motion of the output shaft maintains the tube holder and the tubes in a uniform orientation during shaking as the output shaft, and the fixedly connected tube holder, are driven through the revolving motion about the input axis such that uniform forces are applied to each of the tubes and the samples contained therein to homogenize the samples.

16. The shaking device of claim 15, wherein the fixed gear and the rotary gear have a 1:1 gear ratio.

17. The shaking device of claim 15, wherein fixed gear and the rotary gear are indirectly engaged in an epicyclic gear arrangement.

18. The shaking device of claim 17, wherein fixed gear is a fixed sun gear and the rotary gear is a rotary planet gear, and further including at least one idler gear indirectly engaging the fixed sun gear and the rotary planet gear.

19. The shaking device of claim 15, wherein the fixed gear is annular and concentrically arranged around the input shaft, further comprising a rotational bearing mounted between the fixed gear and the input shaft so that the connector rotates with the input shaft but the fixed gear does not.

20. The shaking device of claim 15, wherein the rotary gear is rotational relative to the connector but not relative to the output shaft, and wherein the connector is rotational relative to the fixed gear.

21. A laboratory homogenizer comprising the shaking device of claim 15, a rotary drive system that engages and drives the rotary input shaft, a control system that controls operation of the drive system, and a frame that supports the shaking device, the drive system, and the control system, wherein the fixed sun gear is fixedly connected in place to the frame.
